(19) United States
(12) Patent Application Publication
(10) Pub. No.: US 2025/0111357 A1
(43) Pub. Date: Apr. 3, 2025

(54) CONTROL METHOD, COMPUTER-READABLE MEDIUM, AND CONTROL DEVICE

(71) Applicant: Panasonic Automotive Systems Co., Ltd., Kanagawa (JP)

(72) Inventor: Hiroshi YAHATA, Osaka Fu (JP)

(73) Assignee: Panasonic Automotive Systems Co., Ltd., Kanagawa (JP)

(21) Appl. No.: 18/802,578

(22) Filed: Aug. 13, 2024

(30) Foreign Application Priority Data
Sep. 28, 2023 (JP) 2023-168345

(51) Int. Cl. G06Q 20/36; H04L 9/00; H04W 4/44

(52) U.S. Cl. CPC G06Q 20/3674; H04L 9/50; H04W 4/44

(57) ABSTRACT

A control method according to the present disclosure is executed by a vehicular system to be mounted on a vehicle. The control method includes: acquiring, from a communication terminal of a user, first wallet information indicating a first wallet associated with authentication information acquired from the communication terminal after the authentication information is determined to be valid by the vehicular system or a computer communicable with the vehicular system; linking vehicle wallet information indicating a vehicle wallet managed by the vehicle to the first wallet information; and storing link information indicating that the vehicle wallet information and the first wallet information are linked, in a memory in the vehicular system.

### CROSS-REFERENCE TO RELATED APPLICATIONS

This application is based upon and claims the benefit of priority from Japanese Patent Application No. 2023-168345, filed on Sep. 28, 2023, the entire contents of which are incorporated herein by reference.

### FIELD

The present disclosure relates to a control method, a computer-readable medium, and a control device.

### BACKGROUND

JP 2021-193524 A discloses a technique for adjusting a fee for an advertisement presented to a user who is to be delivered to a destination by a vehicle, together with a proposal for stopping by the vehicle at a place different from the destination, according to a route indicated by route data.

Further improvements are needed in the technique of payment or receipt of money by a user of a vehicle.

### SUMMARY

A control method according to an aspect of the present disclosure is executed by a vehicular system to be mounted on a vehicle. The control method includes: acquiring, from a communication terminal of a user, first wallet information indicating a first wallet associated with authentication information acquired from the communication terminal after the authentication information is determined to be valid by the vehicular system or a computer communicable with the vehicular system; linking vehicle wallet information indicating a vehicle wallet managed by the vehicle to the first wallet information; and storing link information indicating that the vehicle wallet information and the first wallet information are linked, in a memory in the vehicular system.

### BRIEF DESCRIPTION OF THE DRAWINGS

FIG. 1 is a diagram illustrating an example of an overall configuration of a vehicle payment system according to the present embodiment;

FIG. 2 is a block diagram illustrating an example of a configuration of a vehicle payment system according to the present embodiment;

FIG. 3 is a diagram illustrating screen transition in the information terminal at the time of starting or ending use of a vehicle as a shearing car;

FIG. 4 is a diagram illustrating screen transition in the information terminal at the time of starting or ending use of a vehicle as a shearing car;

FIG. 5A is a block diagram illustrating an example of a functional configuration of the vehicle payment system according to the present embodiment;

FIG. 5B is a sequence diagram illustrating an example of a flow of a transaction process from the use start to the use end of the vehicle in the vehicle payment system according to the present embodiment;

FIG. 6 is a flowchart illustrating an example of a flow of a payment process between an external device, a vehicle, and a user in the vehicle payment system according to the present embodiment;

FIG. 7 is a flowchart illustrating an example of a flow of a payment process between an external device, a vehicle, and a user in the vehicle payment system according to the present embodiment;

FIG. 8 is a flowchart illustrating an example of a flow of an electronic key selection process in the vehicle payment system according to the present embodiment;

FIG. 9 is a diagram for describing an example of processing of notifying a user of a transaction between a vehicle and an external device in the vehicle payment system according to the present embodiment;

FIG. 10 is a diagram for describing an example of processing of notifying a user of a transaction between a vehicle and an external device in the vehicle payment system according to the present embodiment; and

FIG. 11 is a diagram for describing an example of a pattern of a monetary value transaction between an external device, a vehicle, and a user in the vehicle payment system according to the present embodiment.

### DETAILED DESCRIPTION

Hereinafter, an embodiment of an example of a vehicle payment system to which a control method, a program, and a control device according to the present disclosure are applied will be described with reference to the drawings.

### Background to the Present Disclosure

The environment surrounding our daily life is increasingly digitized. For example, many people have a smartphone that is an information terminal dedicated to an individual, and various applications such as an application for managing health of a user and a social communication application for communicating with other people have been installed and used in the smartphone.

The present disclosure discloses a technology for supporting a user so that the user can live a healthy, happy, comfortable, convenient, reassuring, safe, pleasant, economical, reasonable life by cooperatively operating a smartphone that is an information terminal having various pieces of information processing capabilities, an application operating on the smartphone, and an information processing server (hereinafter, the information processing server is referred to as a cloud) that manages and provides various pieces of information.

Note that the present disclosure can also be implemented as a program that causes a computer to execute each characteristic configuration included in the control method used here, or a system operated by the program. Furthermore, it goes without saying that such a computer program can be distributed via a computer-readable non-transitory recording medium such as an SD card or a communication network such as the Internet.

Note that each of the embodiments described below illustrates a specific example of the present disclosure. Numerical values, shapes, configuration elements, steps, order of steps, and the like shown in the following embodiments are merely examples, and do not limit the present disclosure. Further, among the configuration elements in the following embodiments, configuration elements that are not described in independent claims indicating the highest concept are described as any configuration elements. Further, in all the embodiments, the respective contents can be combined.

### First Embodiment

In our society, it is expected that the Internet will become more popular in the future and various sensors will become familiar. As a result, in our society, it is expected that information about an individual's internal state, activities, and the like to information about the entire town including buildings, transportation networks, and the like are digitized and are available in a computer system. Digitized personal data (personal information) is securely managed as big data in a cloud server such as an information bank via a communication network, and is used for various purposes for individuals and society.

Such an advanced information society is referred to as Society 5.0 in Japan. The advanced information society is a society in which economic development and solution of social problems are expected by an information base (cyber-physical system) in which a real space (physical space) which is a material world surrounding an individual and a virtual space (cyberspace) in which various processes related to the physical space are performed in cooperation with computers are highly fused.

In such an advanced information society, by analyzing communication (including acquiring and providing information and a method of expressing the same) and behavior in various daily scenes performed by an individual and analyzing big data including accumulated personal information, it is possible to provide information and services necessary for the individual by a communication method considered to be optimal for the individual according to the scene. In addition, a block chain is developed in an advanced information society, and a vehicle is also one asset managed by the block chain.

Hereinafter, a specific aspect in which various users share and use vehicles in respective forms in an advanced information society in which such a cyber-physical system operates will be described.

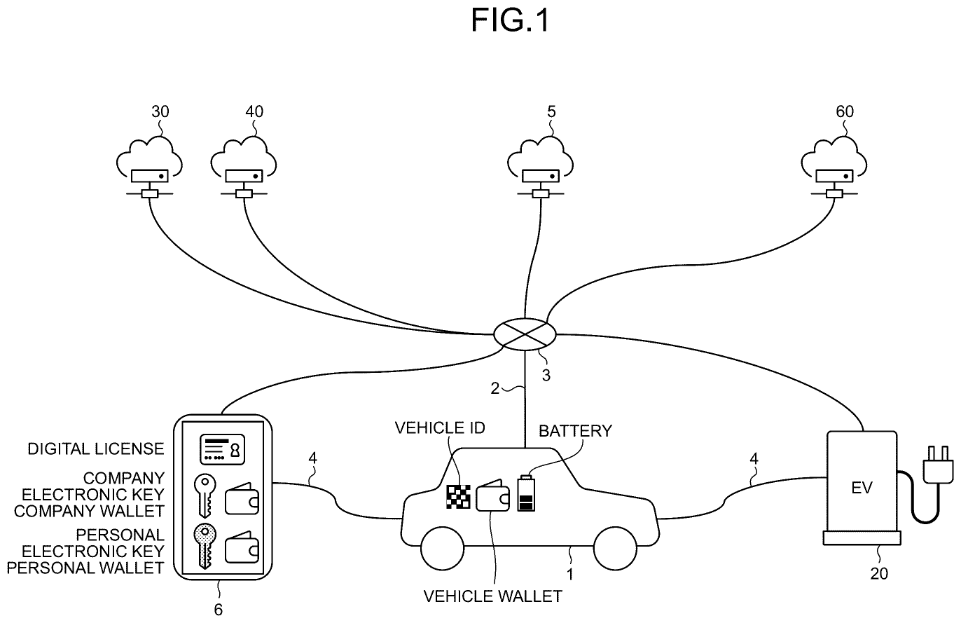

FIG. 1 is a diagram illustrating an example of an overall configuration of a vehicle payment system according to the present embodiment. Here, a vehicle 1 will be described as a sharing car used by an unidentified number of users. The vehicle 1 can access various types of information by connecting to the Internet that is a wide area communication network 3 using wireless communication such as cellular communication 2 called 4G or 5G. Further, the short distance wireless communication 4 can be performed with a short-range device using Bluetooth (registered trademark), an ultra wide band (UWB) which is an ultra-wide band wireless communication standard, or the like. Further, the vehicle 1 can acquire and update an electronic key that can use the vehicle 1 from a vehicle management cloud 5 via the Internet.

In addition, a vehicle ID which is vehicle identification information or a QR code (registered trademark) indicating the vehicle ID is printed on the vehicle 1. Here, the electronic settlement means recorded on the memory of the vehicle 1 is referred to as a vehicle wallet. The vehicle wallet may be a wallet (identified by a unique wallet address) that can handle the crypto asset used in the block chain. Alternatively, the vehicle wallet may have any form as long as it can digitally transact a monetary value (points, currency, crypto assets (including digitized currency), tokens, etc.) with another settlement means, such as a bank account set in the vehicle 1, credit card information, QR payment of a smartphone, or an electronic money account issued by a transportation facility.

In the present embodiment, a cloud (a computer system including one or more computers connected to a computer network) used by a vehicle management company to operate and manage the vehicle 1 is regarded as the vehicle management cloud 5. The vehicle management cloud 5 acquires information about the vehicle via the network to the vehicle 1, and remotely controls the vehicle 1 (vehicle control).

An external device 20 is a generic term for devices such as a gasoline pump, an EV charger, an ETC gate, and a traffic volume sensor installed on a road, that can trade some information or service with a vehicle by wired/wireless communication with a monetary value as a consideration. The external device 20 monitors an operating status of the external device 20 and operates in cooperation with an external device management cloud 60 that remotely controls the external device 20.

The information terminal (smartphone or the like) 6 owned by the user records and manages a digital license of the user, a personal electronic key selected by the user when the user uses the vehicle 1 for personal use, a company electronic key selected when the user uses the vehicle 1 for company business, and a personal wallet and a company wallet (address information or link information about each wallet may be used) associated with each electronic key as a settlement means. Note that an information terminal 6 may manage a digital license of a user and a personal wallet and/or a company wallet in association with each other. In the present embodiment, when the electronic key used to unlock the sharing car or the electronic key assigned for use of the vehicle 1 by the user is a personal electronic key, the personal wallet is automatically selected and used as the settlement means, and when the electronic key is a company electronic key, the company wallet is automatically selected and used as the settlement means.

In the present embodiment, the vehicle 1 that is a sharing car will be described, but the present disclosure is not limited thereto. In a case where the vehicle is temporarily used by an unidentified user and there is a monetary value transaction with the external device 20, it is considered that the present embodiment can be similarly applied. Specifically, the present disclosure may be applied to vehicles used by unidentified users, such as a robot taxi (automatic operation taxi), a sharing motorcycle, a sharing cycle, a sharing kickboard, and a sharing vertical take-off and landing machine (flying taxi).

In addition, information and functions (here, referred to as an intermediary wallet) equivalent to those of the vehicle wallet may be stored in the information terminal 6 of the user without using the vehicle 1. In this case, although the user directly conducts a transaction with the information terminal 6 of the user and the external device 20, the user can conceal the personal information and the settlement means of the user from the external device 20 by conducting a transaction with the external device 20 through an intermediary wallet not related to the personal information and the settlement means of the user. Such a usage mode may be applied to payment of a boarding fee when getting on an airplane, a ship, a train, a bus, a taxi, or the like, payment of a shopping fee at a retail store, and the like.

A personal cloud 30 is a cloud that manages a user's personal electronic key, personal information including a personal wallet, and a settlement means. For example, the personal cloud 30 stores a use history of a personal electronic key of a user, a transaction history of a personal wallet, and the like. Similarly, a company cloud 40 stores a user's company electronic key, a history of using a company wallet, and the like. In addition, it may have a function of determining usage authorization when the user starts using the company electronic key.

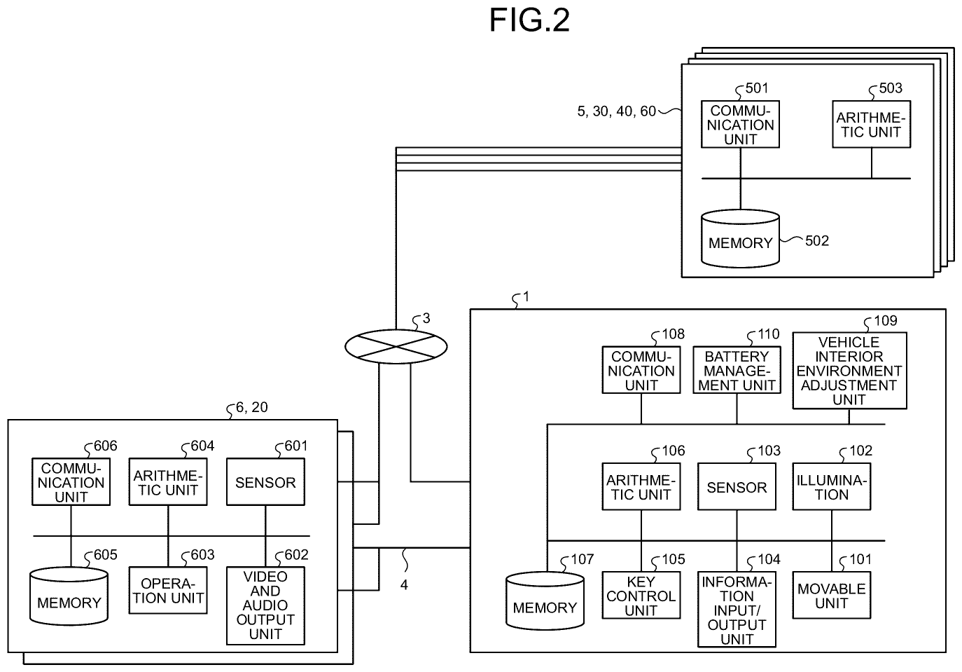

FIG. 2 is a block diagram illustrating an example of a configuration of a vehicle payment system according to the present embodiment. The information terminal 6 includes a sensor unit 601 that acquires video information, audio information, and/or a physical quantity of a surrounding environment, a video and audio output unit 602 that outputs video and audio, an operation unit 603 that receives button pressing, touch operation, or the like from a user, an arithmetic unit 604 that performs information processing such as various calculations and information drawing performed in the information terminal 6, a memory 605 that holds data and files used by the arithmetic unit 604, and a communication unit 606 that communicates with another computer on a communication network.

When an application for key management is installed in the information terminal 6, a program and necessary data are recorded in the memory 605 of the information terminal 6, and the program is executed by the arithmetic unit 604.

Note that the information terminal 6 will be described as a smartphone, but is not limited thereto. It may be in the form of a wristwatch-type smartwatch, a glasses-type smart glass, a ring-type smart ring, a smart speaker that responds to voice commands, or a robot that also includes a movable unit.

The vehicle management cloud 5 includes a communication unit 501 that communicates with another computer on the communication network, a memory 502 that records information about the vehicle 1 and the user and a management program thereof, and an arithmetic unit 503 that performs various pieces of data processing.

As in the vehicle management cloud 5, the external device management cloud 60, the personal cloud 30, and the company cloud 40 include the communication unit 501 that communicates with another computer on a communication network, the memory 502 that records information about a vehicle and a user and a management program thereof, and an arithmetic unit 503 that performs various pieces of data processing.

The vehicle 1 includes a movable unit 101 that moves the vehicle 1 or a device (seat or the like) in a vehicle interior space, an illumination unit 102 that illuminates the periphery of the vehicle 1, a sensor unit 103 that detects a position and a state of a person or a car around the vehicle 1 and/or a person or an object in the vehicle interior, an information input/output unit 104 that provides various video and audio information to a passenger and receives an input such as a touch operation and an audio operation from the passenger, a key control unit 105 that authenticates a key to be unlocked and controls locking/unlocking of a door of the vehicle 1, an arithmetic unit 106 (an example of a control device) that executes various processes related to a vehicle backbone system and a vehicle function, a memory 107 that records various pieces of data including a program of the vehicle backbone system and a database of key management, a communication unit 108 that performs wireless communication with the external device 20, a vehicle interior space control unit 109 that sets air conditioning for a driver seat and/or an air conditioning for the entire vehicle interior, and sets presence or absence of power supply to a USB port provided in the vehicle 1, a maximum current amount, and a supported version of a Universal Serial Bus (USB) standard, a battery management unit 110 that controls charging and discharging of a battery of the vehicle 1, and the like.

Note that the vehicle management cloud 5, the external device management cloud 60, the personal cloud 30, the company cloud 40, the vehicle 1, and the information terminal 6 may communicate by a communication means other than the Internet of the wide area communication network 3. For example, the short distance wireless communication 4 may be used for the unlocking process performed between the vehicle 1 and the information terminal 6.

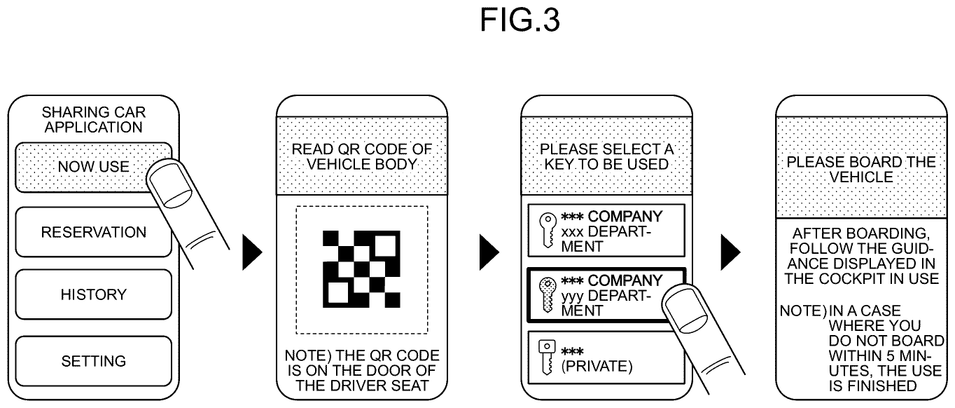

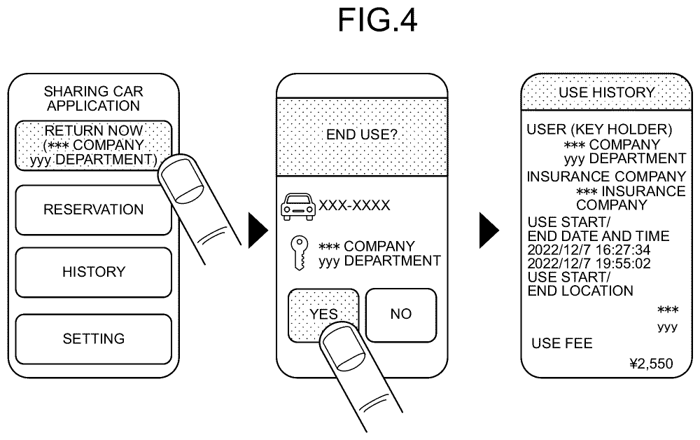

FIGS. 3 and 4 are diagrams illustrating screen transitions in the information terminal 6 when the use of the vehicle 1 as the sharing car is started or ended. FIG. 3 illustrates screen transition at the start of use. First, the user activates an application “sharing car application” for using a sharing car, the application being installed in the information terminal 6. The activated screen is the first (leftmost) screen, and the screen displays a “NOW USE” button for immediately starting use, a “RESERVATION” button for reserving a sharing car, a “HISTORY” button for confirming a past use history, and a “SETTING” button for confirming and setting personal information about a user and setting information about an electronic key.

When the user selects the “NOW USE” button by a touch operation or the like through the operation unit 603, the screen transitions to a screen for reading a two-dimensional code attached to the vehicle 1 in order to identify the vehicle 1 to be used. By placing the two-dimensional code of the vehicle 1 in the dashed square of the screen, the sharing car application can identify the vehicle 1 (vehicle ID).

When the vehicle 1 is identified, the screen transitions to a screen for selecting a key for using the vehicle 1. Here, three keys are illustrated. A first key selected in a case where the vehicle 1 is used for the purpose of business of the xxx department of the *** company, a second key selected in a case where the vehicle 1 is used for the purpose of business of the yyy department of the same *** company that the user also serves, and a third key selected in a case where the user uses the vehicle 1 for private purposes are displayed. In FIG. 3, a user C selects the second key according to the purpose of vehicle use. That is, the vehicle 1 is intended to be used for the purpose of business of the yyy department that the user serves.

When the key is selected, the arithmetic unit 503 of the vehicle management cloud 5 determines whether the vehicle 1 can be used, and in a case where the use is permitted, a message indicating that boarding is possible is displayed. In this example, after getting in the vehicle 1, a notification that guidance such as a method of starting the vehicle 1 and a method of operating the end of use is presented is made to the information input/output unit 104 (for example, a monitor located in the cockpit) provided in the vehicle 1.

In addition, in a case where the boarding act is not detected within a predetermined time (for example, in a case where neither the door nor the trunk of the vehicle 1 is unlocked), the use may be automatically terminated. The function of the automatic cancellation and the presentation thereof are also used to suppress an increase in the use fee for the subscriber to a predetermined amount or more and to have the vehicle 1 used by another user in a case where the start of usage is not detected even after a predetermined time elapses from the usage start time of the reserved vehicle 1.

FIG. 4 illustrates screen transition at the end of use. In a case where the user performs a use termination operation on the information terminal 6, the user can terminate use by activating the sharing car application and selecting the “RETURN NOW” button. For easy understanding, information indicating a key to be returned may be displayed on the screen. When the “RETURN NOW” button is selected, the screen shifts to a confirmation screen for the end of use. On the confirmation screen, vehicle information (external image of the vehicle 1, number of the vehicle 1, and the like) in which use is to be ended and key information (information about the key owner and the like) are displayed on the information terminal 6.

When the intention to end the use is confirmed on the confirmation screen, the use history information including the user who used the vehicle, the key used, the vehicle used, the use start/end date and time, the use start/end place, the use fee, and the like is displayed on the information terminal 6.

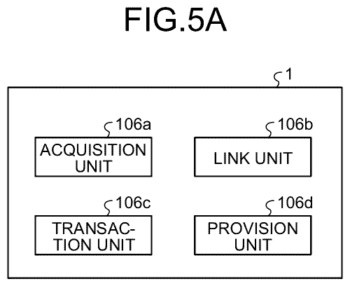

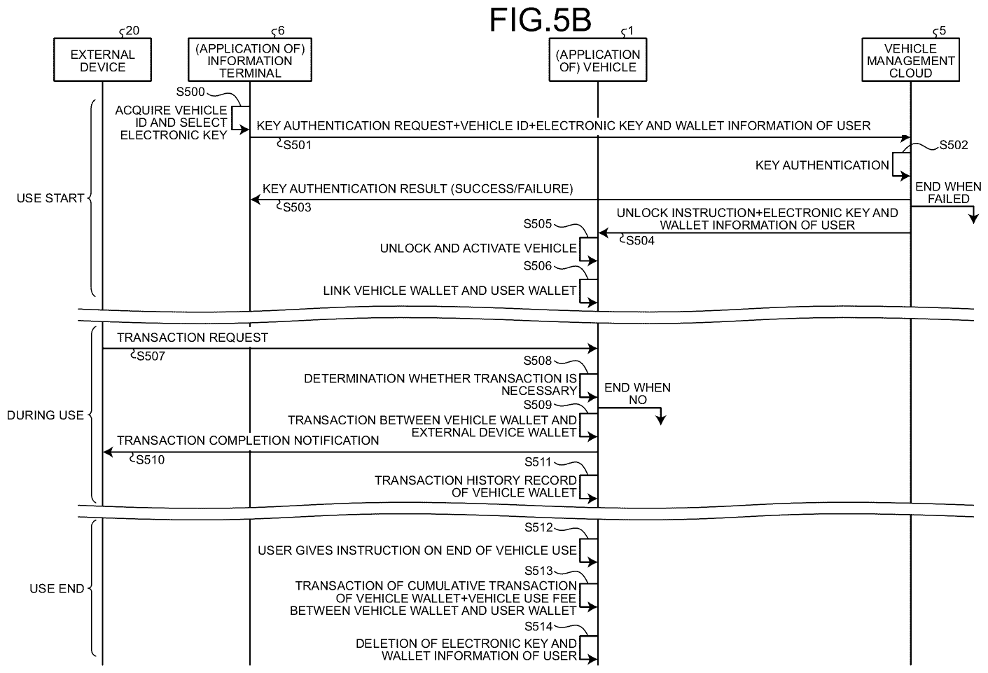

FIG. 5A is a block diagram illustrating an example of a functional configuration of the vehicle according to the present embodiment. In the present embodiment, the arithmetic unit 106 executes a program stored in the memory 107, so that the vehicle 1 implements an acquisition unit 106a, a link unit 106b, a transaction unit 106c, a provision unit 106d, and the like. In the present embodiment, the acquisition unit 106a, the link unit 106b, the transaction unit 106c, the provision unit 106d, and the like are implemented in the vehicle 1, but may be implemented in cooperation with the information terminal 6 of the user or the vehicle management cloud 5.

After it is determined that the authentication information (for example, the vehicle ID, the user's electronic key, the user wallet information indicating the user wallet) acquired from the information terminal 6 (an example of a communication terminal) of the user is valid in the vehicular system or a computer (for example, the arithmetic unit 503 of the vehicle management cloud 5) capable of communicating with the vehicular system, the acquisition unit 106a acquires user wallet information (an example of first wallet information) indicating a user wallet (an example of a first wallet) associated with the authentication information from the information terminal 6 (alternatively, the vehicle management cloud 5). Here, the vehicular system may be a system to be mounted on the vehicle 1, and may be a vehicular device including the arithmetic unit 106, the memory 107, and the like. In the present embodiment, the vehicle management cloud 5 determines whether the authentication information acquired from the information terminal 6 is valid, but the determination is not limited thereto, and may be performed in the vehicle 1.

The link unit 106b links the vehicle wallet information indicating the vehicle wallet managed by the vehicle 1 to the user wallet information. In addition, the link unit 106b stores link information indicating that the vehicle wallet information and the user wallet information are linked in the memory 107 in the vehicular system. Accordingly, in a case where the vehicle 1 has a wallet (settlement means), a transaction is performed between the external device 20 and the vehicle 1, and a transaction is performed between the vehicle 1 and a user wallet (settlement means) of a user (information terminal 6), whereby it is possible to prevent information about the user from leaking to the external device 20 at the time of the transaction. That is, by connecting the user wallet, the vehicle wallet, and the external device wallet in series, the user wallet associated with the electronic key to be used can be concealed from the external device 20.

Here, the information terminal 6 may manage (store) a plurality of electronic keys (for example, a personal electronic key, a company electronic key, or the like) available to the user and a plurality of pieces of wallet information indicating a plurality of wallets held by the user in association with each other. In addition, the authentication information may include an electronic key (an example of a first electronic key) selected by the user from among a plurality of electronic keys. In this case, after the authentication information is determined to be valid, the acquisition unit 106a may acquire wallet information associated with the first electronic key among a plurality of pieces of wallet information managed by the information terminal 6 from the information terminal 6 as the user wallet information.

Furthermore, here, the plurality of pieces of wallet information may be information related to a plurality of settlement services available to the user. In this case, the first electronic key may be selected based on one settlement service selected by the user from a plurality of settlement services via the GUI of the information terminal 6.

The plurality of electronic keys may include a company electronic key (an example of a company key) associated with a company to which the user belongs and a personal electronic key (an example of a personal key) of the user. In this case, in a case where the selected first electronic key is the company electronic key, the link unit 106b links the company wallet information indicating the company wallet managed by the company to the vehicle wallet information as the user wallet information. Furthermore, in a case where the selected first electronic key is a personal electronic key, the link unit 106b links personal wallet information indicating a wallet of an individual user to the vehicle wallet information as the user wallet information.

The transaction unit 106c executes a payment process of paying money to an external device wallet (an example of an external wallet) of the external device 20 from a user wallet via the vehicle wallet in response to a request by the external device 20 outside the vehicle 1 or the vehicular system. Here, the payment process includes paying money to the external device wallet from the vehicle wallet based on the vehicle wallet information, and remitting money paid from the user wallet to the vehicle wallet based on the vehicle wallet information and the user wallet information. Note that, although the money transfer is described here, the money includes not only cash but also points including economic values, crypto assets, tokens expressing some rights, and the like.

The same applies to a case where the user wallet receives money from the external device 20. In this case, the transaction unit 106c executes the payment process of paying money to the user wallet from the external device wallet of the external device 20 via the vehicle wallet in response to a request by the external device 20 or the vehicular system outside the vehicle 1. Here, the payment process includes paying money to the vehicle wallet from the external device wallet based on the vehicle wallet information and the external device wallet, and remitting money paid from the vehicle wallet to the user wallet based on the vehicle wallet information and the user wallet information. In addition, the payment of money from the vehicle wallet to the external device wallet is performed without transmitting an ID for identifying the user (user ID), the information terminal 6 (application ID, information terminal 6 ID), or user wallet information (user wallet address and the like) to the external device 20.

In addition, the vehicle wallet information includes a vehicle wallet address indicating an address of the vehicle wallet. In addition, the user wallet information includes a user wallet address indicating an address of the user wallet. In this case, the payment from the vehicle wallet to the external device wallet may be made by recording the first payment transaction using the address of the external device wallet acquired from the external device 20 and the vehicle wallet address on the block chain. In addition, the payment from the user wallet to the vehicle wallet may be made by recording the second payment transaction using the user wallet address and the vehicle wallet on the block chain.

In addition, the payment from the vehicle wallet to the external device wallet may be executed at the first timing when a request for payment is made between the external device 20 and the vehicle 1. Then, the payment from the user wallet to the vehicle wallet may be made at the second timing after the first timing. Here, the second timing may be a timing at which the user suspends or ends the use of the vehicle 1 or a timing at which a preset period ends.

In addition, in the payment from the vehicle wallet to the external device wallet, the payment of the first amount of money requested from the external device 20 may be executed. In addition, in the payment from the user wallet to the vehicle wallet, the payment of the second amount of money different from the first amount of money may be executed.

Further, the transaction unit 106c may acquire the permission information from the information terminal 6 in advance after linking the vehicle wallet information to the user wallet information. Here, the permission information may indicate that the vehicular system has temporary authority to request and execute money transfer from the user wallet to the vehicle wallet. In this case, the receipt of the payment from the user wallet to the vehicle wallet is performed based on the permission information before or after the payment from the vehicle wallet to the external device wallet.

Payment from the user wallet to the vehicle wallet may be made in advance by transferring a predetermined amount from the user wallet to the vehicle wallet after linking the vehicle wallet information to the user wallet information (prepaid). In this case, the payment from the vehicle wallet to the external device wallet may be made within a predetermined amount at a timing when a request for payment is made between the external device 20 and the vehicle 1.

The money remittance process from the vehicle wallet to the external device wallet may be executed by recording a payment transaction using the vehicle wallet address and the external device wallet address on the block chain. In addition, the money remittance process between the user wallet and the vehicle wallet corresponding to this may be executed by a settlement method that does not involve recording on a block chain in order to avoid tracking from a third party.

In addition, the payment process may be executed through an intermediary wallet different from the vehicle wallet in addition to the vehicle wallet. In this case, the receipt of money from the user wallet in the payment process includes payment from the user wallet to the intermediary wallet and payment from the intermediary wallet to the vehicle wallet. Also, payment from a vehicle wallet to an external device wallet, payment from an intermediary wallet to a vehicle wallet, and payment from a user wallet to an intermediary wallet are made by recording, on a block chain, respective payment transactions. Furthermore, the timings at which at least two of the respective payment transactions are recorded may be different.

In addition, after the payment process, the transaction unit 106c may transmit a payment report indicating that the payment process is completed to the information terminal 6. Here, the payment report may include payee information for identifying the external device 20 or the external device wallet, and payment amount information.

In addition, after the payment process, the transaction unit 106c may display a payment report indicating that the payment process is completed on the information input/output unit 104 (an example of a display) mounted on the vehicle 1. The display content of the payment report may include a display object for identifying the external device 20.

Furthermore, in a case where the external device is a charger for charging the battery of the vehicle 1, the payment report may include information about the amount of charge to the battery.

In addition, in a case where the selected electronic key is a company electronic key, after the payment process, the transaction unit 106c may transmit a payment report indicating that the payment process using the company wallet is completed to the company cloud 40 (an example of a company server) associated with the company to which the user belongs. In addition, in a case where the selected electronic key is a personal electronic key, after the payment process, the transaction unit 106c may transmit a payment report indicating that the payment process using the user wallet is completed to the information terminal 6 or the personal cloud 30 (an example of a personal server) used by the user.

The transaction unit 106c executes a reception process for receiving money paid to the user wallet from the external device wallet of the external device 20 via the vehicle wallet in response to a request by the external device 20 or the vehicle 1 outside the vehicle 1. Here, the reception process may include receiving money paid from the external device wallet to the vehicle wallet based on the vehicle wallet information, and remitting money from the vehicle wallet to the user wallet based on the vehicle wallet information and the user wallet information. The receipt of money paid from the external device wallet to the vehicle wallet may be executed without transmitting an ID for identifying the user (user ID), the information terminal 6 (application ID, information terminal 6 ID), or user wallet information (user wallet address and the like) to the external device 20.

The money remittance process from the external device wallet to the vehicle wallet may be executed by recording a payment transaction using the wallet address indicated by the vehicle wallet information on the block chain. In addition, the money remittance process between the vehicle wallet and the user wallet corresponding to this may be executed by a settlement method that does not involve recording on a block chain in order to avoid tracking from a third party.

In the present embodiment, the transaction unit 106c exchanges money between the vehicle wallet and the external device wallet in the payment process and the reception process with the external device 20, but can also exchange money with the external device management cloud 60. In addition, in a case where the transaction unit 106c is realized in the vehicle management cloud 5, it is also possible to exchange money between the vehicle wallet and the external device wallet in the payment process and the reception process between the vehicle management cloud 5 and the external device 20 (or the external device management cloud 60).

The provision unit 106d may provide sensing data (an example of the detection data) acquired by the vehicle 1 detecting the traveling state or the situation around the vehicle 1 to the traffic infrastructure system related to the road on which the vehicle 1 travels. In this case, the external device 20 may be at least part of the traffic infrastructure system. Then, the payment from the external device wallet may be payment of a consideration for providing the sensing data to the traffic infrastructure system. For example, there may be a case where the acquisition unit 106a acquires position information about the vehicle 1 at predetermined time intervals, and movement history information acquired by collecting the position information within the past predetermined time is transmitted together with a vehicle ID (and/or user ID, a vehicle wallet, ETC onboard device ID) from the communication unit 108 to the external device 20 installed along the road, and the external device 20 pays a consideration to the vehicle 1 for providing the movement history information.

FIG. 5B is a sequence diagram illustrating an example of a flow of a transaction process from the start of use to the end of use of the vehicle in the vehicle payment system according to the present embodiment. When the user starts using the vehicle 1, the user first acquires the vehicle ID of the vehicle 1 to be shared using the information terminal 6 (the sharing car application of the information terminal 6) and selects the electronic key (Step S500). For example, the information terminal 6 acquires a vehicle ID by reading a QR code printed near a driver seat door of the vehicle 1 with a sharing car application, and starts a transaction process. Then, the information terminal 6 transmits a key authentication request to the vehicle management cloud 5 (Step S501).

At this time, the information terminal 6 also transmits, to the vehicle management cloud 5, authentication information including a target vehicle ID (information based on the QR code), an electronic key assigned (selected) by the user at the time of use, and user wallet information indicating a user wallet that is a settlement means corresponding to the electronic key. The vehicle management cloud 5 authenticates the electronic key (Step S502), and returns the result (key authentication result) (Step S503). Here, in a case where the key authentication fails, the transaction process is terminated. In a case where the operation is successful, the vehicle management cloud 5 subsequently transmits a door unlock instruction, an electronic key assigned by the user, and user wallet information to an application (hereinafter, the vehicle 1 or this application is referred to as a vehicle 1) operating on the vehicle 1 or a computer system (including the arithmetic unit 106, the memory 107, the communication unit 108, and the information input/output unit 104) mounted on the vehicle 1 (Step S504).

The acquisition unit 106a of the vehicle 1 acquires the unlock instruction, the electronic key, and the user wallet information from the vehicle management cloud 5. The vehicle 1 unlocks the door upon receiving this, and the vehicle 1 is activated (Step S505). In addition, the link unit 106b of the vehicle 1 links the vehicle wallet information and the user wallet information (Step S506). That is, the user wallet information is recorded in the memory 107 so that the total transaction between the external device 20 and the vehicle wallet during the use period when the user uses the vehicle 1 can be sequentially or collectively billed to or paid by the user wallet.

While the user is using the vehicle 1, a monetary value transaction request with the external device 20 occurs each time. This includes both a payment request for traveling on a toll road, charging of a battery, refueling of gasoline, and the like, and a request for transfer of a consideration for sharing information about vehicle sensor data, the vehicle 1, or a passenger. When the external device 20 transmits a transaction request to the vehicle 1 (Step S507), the vehicle 1 determines whether the transaction request is necessary (Step S508). In a case where it is determined that the transaction is unnecessary, the transaction process is terminated here, and in a case where it is determined that the transaction is necessary, the following processing is continued.

The transaction unit 106c of the vehicle 1 performs a transaction (exchange of a monetary value) between the vehicle wallet and the external device wallet (or the settlement means) according to the transaction request (Step S509). Then, the information indicating that the transaction is completed is returned to the external device 20 (Step S510). If this transaction is recorded on the block chain, both the external device 20 and the vehicle 1 can refer to and confirm the record of the transaction. Thereafter, the vehicle 1 manages, in the memory 107, the entire transaction record between the external device 20 and the vehicle 1 that has occurred while the user is using the vehicle 1 (Step S511). The transaction history record may be managed by the memory 107 of the vehicle 1, may be transmitted to the vehicle management cloud 5 and managed, or may be referred to in a case where the transaction history record is recorded on the block chain.

When the user terminates the use of the vehicle 1, the user selects the end of use via the information input/output unit 104 of the vehicle 1 and instructs the vehicle 1 to start the use termination processing (Step S512). The transaction unit 106c of the vehicle 1 executes a transaction of charging the user wallet to pay to the vehicle wallet a monetary value including the cumulative amount traded between the external device 20 and the vehicle 1 while the user uses the vehicle 1 and the use fee of the vehicle 1 (Step S513). If the payment results in a negative balance, the transaction unit 106c executes a transaction for paying the monetary value from the vehicle wallet to the user wallet. In addition, with the end of use, the vehicle 1 deletes the electronic key and the user wallet information used by the user from the memory 107 (Step S514).

Note that, in the present disclosure, the above embodiment is described as an example, but the present disclosure is not limited thereto, and similar effects and objects may be realized in different forms. The important point is that the vehicle 1 can temporarily process the transaction of the monetary value with the external device 20 as a transaction partner while the user uses the vehicle 1. The vehicle 1 transacts, for the user wallet, a transaction or a transaction cumulative amount with the external device 20 with respect to the user wallet every time a transaction with the external device 20 occurs (that is, sequentially), or collectively at the end of use of the user, or the like. As described above, by not allowing direct transaction between the external device 20 and the user via the vehicle 1 (vehicle wallet), it can be expected that the user (user's personal information, electronic key, user wallet information, and the like) of the vehicle 1 is concealed from the external device 20 or a third party participating in the block chain network and cannot be identified. This leads to protection of privacy of a user of the vehicle 1 such as a sharing car.

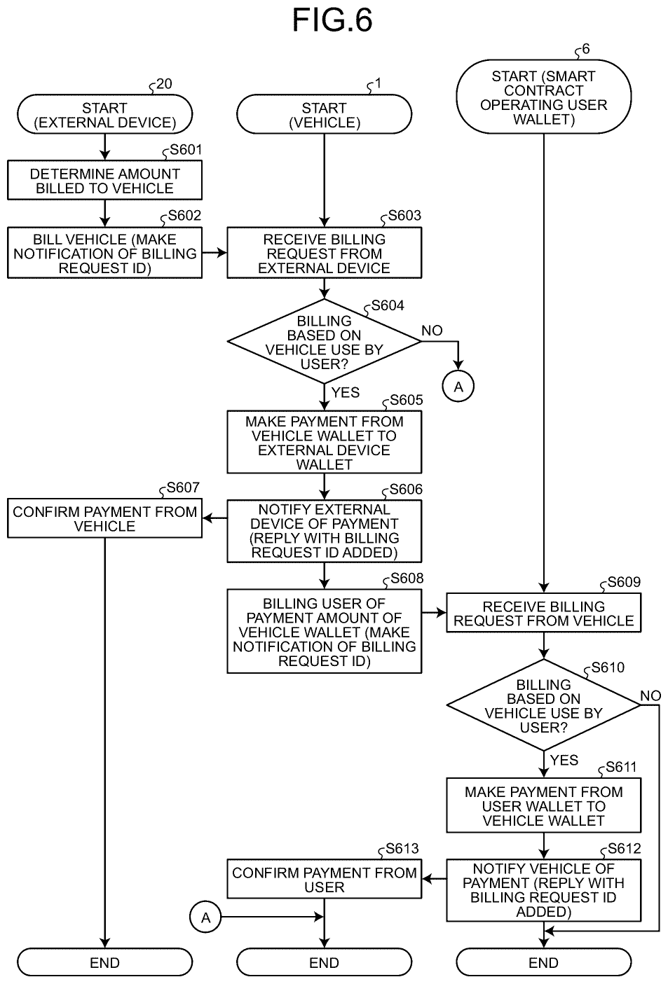

FIG. 6 is a flowchart illustrating an example of a flow of the payment process between an external device, a vehicle, and a user in the vehicle payment system according to the present embodiment. Here, an example of a flow of processing in which the external device 20 charges the vehicle 1 and then the vehicle 1 charges the user will be described. Furthermore, here, a time point at which payment to the external device 20 is necessary and the monetary value (amount billed) of the payment is determined based on the use of the vehicle 1 by the user, such as when the user finishes refueling gasoline, when the user finishes charging the battery, or when the user passes through a gate of a toll road, will be described as the start timing of the processing.

Note that, before this payment occurs, for example, when the user starts using the vehicle 1, the user has agreed with the vehicle management company in advance on the payment conditions, and the agreement is recorded on the block chain. In addition, in a case where there is a request from the vehicle wallet to the user wallet based on the agreement, the following description will be made assuming that the description is made in the smart contract, (the application of) the information terminal 6, the vehicle 1 or the vehicle management cloud 5 (alternatively, the application of the vehicle management cloud 5) so that payment is automatically made in response to the request as long as it is within the use period of the user.

First, when the amount billed (money billed) to the vehicle 1 is determined (step S601), the external device 20 notifies the vehicle 1 of the billing request ID and charges the vehicle 1 for the amount billed (Step S602). Note that the billing request ID for identifying the transaction between the external device 20 and the vehicle 1 and the billing request ID for identifying the transaction between the vehicle 1 and the user are information used by the billing side to identify the transaction. Therefore, the same information may or may not be used.

When receiving the billing request (billing request ID) from the external device 20 (Step S603), the transaction unit 106c of the vehicle 1 determines whether it is a billing request based on use of the vehicle 1 by the user (Step S604). In a case where the request is not a billing request based on the use of the vehicle 1 by the user (Step S604: No), the transaction unit 106c of the vehicle 1 ends the payment process. On the other hand, in a case where the request is a billing request based on the use of the vehicle 1 by the user (Step S604: Yes), the transaction unit 106c of the vehicle 1 performs the payment process from the vehicle wallet to the external device wallet (Step S605). Next, the transaction unit 106c of the vehicle 1 notifies the external device 20 of the implementation of the payment process (Step S606). At this time, the transaction unit 106c of the vehicle 1 attaches a billing request ID. The external device 20 confirms implementation of the payment process notified from the vehicle 1 (Step S607). In addition, the transaction unit 106c of the vehicle 1 charges the amount of paid from the vehicle wallet to the user wallet or the information terminal 6 operated by the user (Step S608). At this time, the transaction unit 106c of the vehicle 1 also accompanies it with a billing request ID.

The information terminal 6 on which the application for managing the transaction of the user wallet is operated or the smart contract registered on the block chain in which the agreement by the user with the vehicle management company is described receives or detects the request for billing the payment amount from the vehicle 1 (Step S609). Next, the information terminal 6 or the smart contract determines whether the received request is based on the use of the vehicle 1 by the user (Step S610). In a case where the received billing request is not a request based on the use of the vehicle 1 by the user (Step S610: No), the information terminal 6 or the smart contract ends the payment process. On the other hand, in a case where the received billing request is a request based on use of the vehicle 1 by the user (Step S610: Yes), the information terminal 6 or the smart contract performs payment from the user wallet to the vehicle wallet (Step S611). Next, the information terminal 6 or the smart contract notifies the vehicle 1 of the payment (Step S612). At this time, the information terminal 6 or the smart contract accompanies it with a billing request ID and makes a notification of the payment. The transaction unit 106c of the vehicle 1 confirms payment from the user wallet to the vehicle wallet (Step S613).

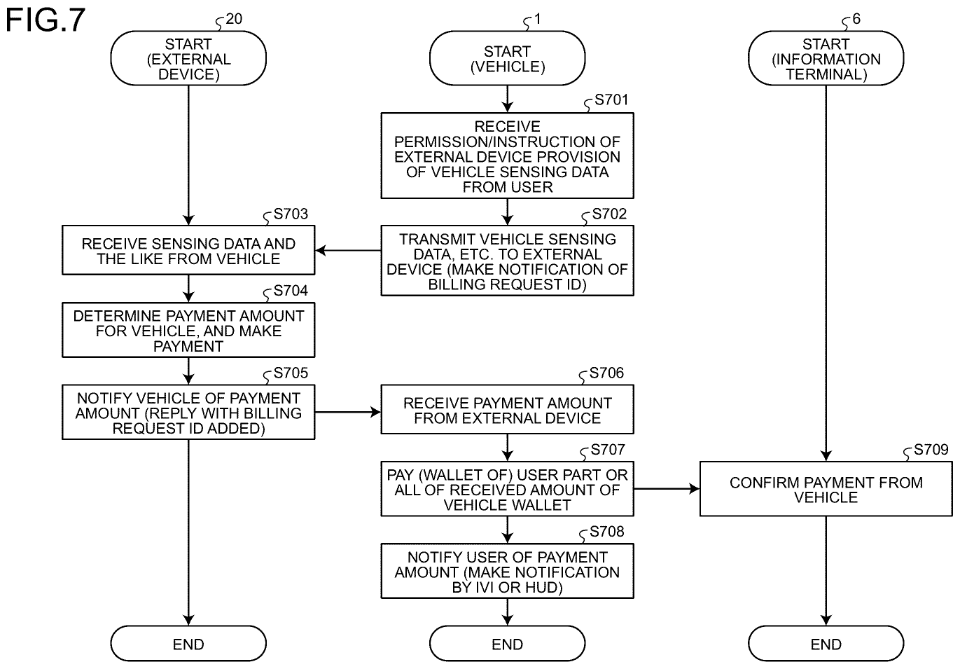

FIG. 7 is a flowchart illustrating an example of a flow of the payment process between an external device, a vehicle, and a user in the vehicle payment system according to the present embodiment. Here, an example of a flow of processing in which the vehicle 1 makes a request of the external device 20 as a consideration for uploading sensing data of the vehicle 1 and makes a notification of an amount paid to the wallet of the user will be described.

Furthermore, here, for example, a time point at which a transfer from the external device 20 is made and the monetary value (for example, the payment amount) of the transfer is determined based on the use of the vehicle 1 by the user such as when the sensing data sensed by the sensor unit 103 of the vehicle 1 is transmitted to the external device 20, when information about the vehicle 1 or the user is transmitted to the external device 20, or when the vehicle 1 or the user transmits a reply to an inquiry or a question from the external device 20 will be described as the start timing of processing.

Note that, before this transfer occurs, for example, when the user starts using the vehicle 1, the user has agreed with the vehicle management company in advance on the transfer condition, and the agreement is recorded on the block chain. In addition, in a case where there is a transfer request from the vehicle wallet to the user wallet based on the agreement at that time, as long as it is within the use period of the user, the following description will be made assuming that the description is made in in the smart contract, (the application of) the information terminal 6, the vehicle 1, or the vehicle management cloud 5 (the application of the vehicle management cloud 5) such that the transfer is automatically made in response to the request.

When permission or an instruction to provide the sensing data acquired by the vehicle 1 to the external device 20 is received from the user (Step S701), a provision unit 106e of the vehicle 1 transmits the sensing data of the vehicle 1 to the external device 20 (Step S702). At this time, the provision unit 106d of the vehicle 1 notifies the external device 20 of the billing request ID.

Upon receiving the sensing data from the vehicle 1 (Step S703), the external device 20 determines a payment amount to the vehicle 1 and pays the determined payment amount from the external device wallet to the vehicle wallet (Step S704). Next, the external device 20 notifies the vehicle 1 of the determined payment amount (Step S705). At this time, the external device 20 assigns the received billing request ID and notifies the vehicle 1 of the determined payment amount.

When receiving the payment amount from the external device 20 (Step S706), the transaction unit 106c of the vehicle 1 pays the received payment amount from the vehicle wallet to the user wallet (Step S707). Next, the transaction unit 106c of the vehicle 1 displays the payment amount to the user on the information input/output unit 104 to notify the user of the amount (Step S708).

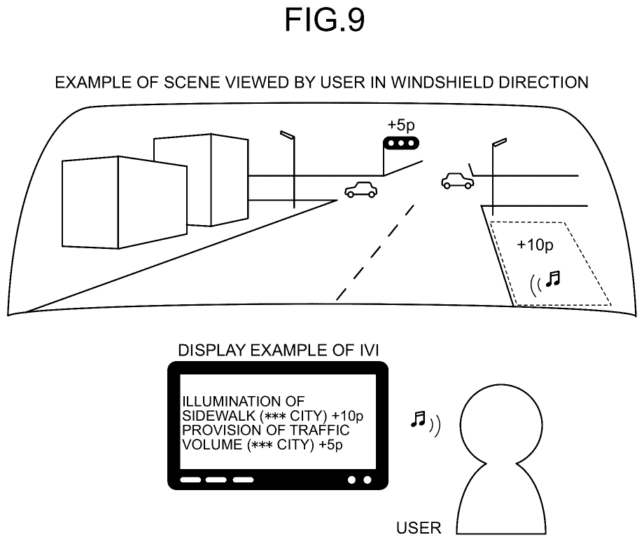

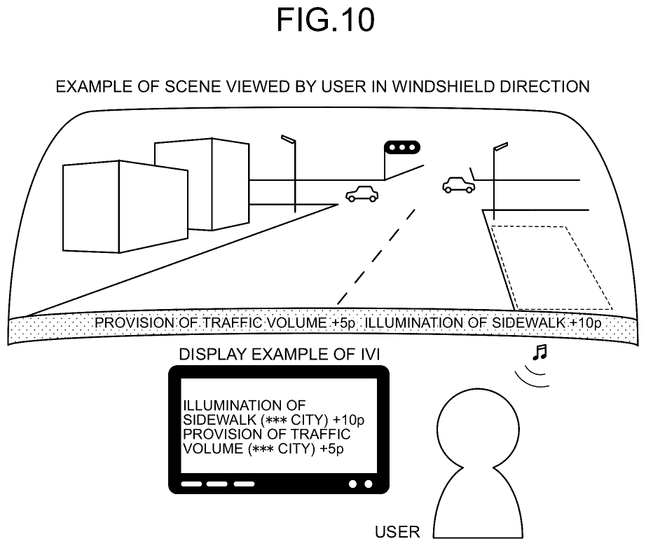

In a case where notifying the user of the payment amount, the user is notified of the payment amount using the information input/output unit 104 of the vehicle 1. As a result, the user of the information terminal 6 confirms the payment amount from the vehicle 1 (Step S709). Furthermore, it is conceivable to notify the user of the amount using an in-vehicle infotainment (IVI) or a head up display (HUD) of the vehicle 1. Specifically, as illustrated in FIGS. 9 and 10 to be described later, it is conceivable to notify the user of the transaction between the vehicle 1 and the external device 20 in an easy-to-understand manner. Note that, in FIGS. 6 and 7, description is made in which every time there is a transaction between the external device 20 and the vehicle 1, a transaction for compensating the transaction is executed between the vehicle 1 and the user wallet, but the present disclosure is not limited thereto. For a plurality of transactions between the external device 20 and the vehicle 1, the user wallet may collectively transact with the vehicle wallet (via the intermediary wallet when necessary) at a time.

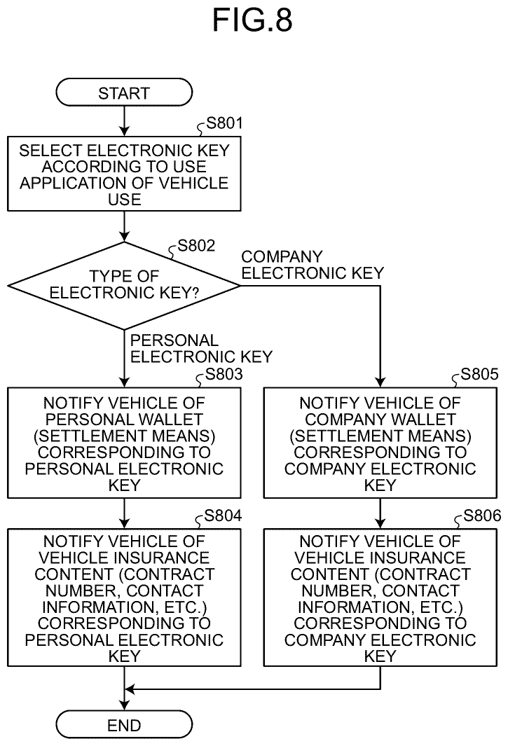

FIG. 8 is a flowchart illustrating an example of a flow of an electronic key selection process in the vehicle payment system according to the present embodiment. FIG. 8 is a flowchart illustrating that a wallet of the user is selected according to the electronic key selected when the user starts using the vehicle 1 and is notified to the vehicle 1.

After the user inputs the vehicle ID to the information terminal 6, one electronic key of a plurality of electronic keys held by the user is selected according to the usage purpose of the vehicle 1. In a case where the electronic key is a personal electronic key indicating personal use, the information terminal 6 (alternatively, the application of the information terminal 6) notifies the vehicle 1 of wallet information indicating a personal wallet or a settlement means corresponding to the personal electronic key as user wallet information.

In addition, vehicle insurance content corresponding to the personal electronic key, for example, an insurance contract number, contact information about an insurance company, and the like are notified to the vehicle 1. In the information terminal 6 (alternatively, the application of the information terminal 6), the vehicle insurance applied to each electronic key is set in advance, and information about the vehicle insurance is temporarily shared with the vehicle 1 until the end of the usage period, so that it is possible to confirm safety of the user and grasp an accident situation via the information input/output unit of the vehicle 1 in the event of an accident. The same applies to the case of the company electronic key. As in the personal wallet, the company wallet may be a wallet on a block chain or a settlement means such as a credit card, but is characterized by being associated with a budget code for each department of the company. Note that, although it is described that the notification is given to the vehicle 1 in the flowchart, the notification may be given to the vehicle management cloud 5 instead of the vehicle 1 as described above.

First, when the user selects an electronic key according to the use application of the vehicle 1 (Step S801), the information terminal 6 determines whether the selected type of electronic key is a personal electronic key or a company electronic key (Step S802). In a case where the electronic key selected by the user is a personal electronic key (Step S802: personal electronic key), the information terminal 6 notifies the vehicle 1 of a personal wallet (alternatively, settlement means) corresponding to the selected personal electronic key (Step S803). In addition, the information terminal 6 notifies the vehicle 1 of vehicle insurance content (contract number, contact information, etc.) corresponding to the selected personal electronic key (Step S804).

In a case where the electronic key selected by the user is a company electronic key (Step S802: company electronic key), the information terminal 6 notifies the vehicle 1 of a company wallet (alternatively, settlement means) corresponding to the selected company electronic key (Step S805). In addition, the information terminal 6 notifies the vehicle 1 of vehicle insurance content (contract number, contact information, etc.) corresponding to the selected company electronic key (Step S806). As described above, not only the wallet to be the settlement means is selected according to the electronic key selected by the user according to the use application of the vehicle, but also the vehicle insurance content associated with the electronic key is notified to the vehicle 1 (or the vehicle management cloud 5), so that it is possible to quickly share the situation with the insurance company when a trouble including an accident or the like occurs in the vehicle 1. Furthermore, it is also conceivable that the vehicle 1 automatically sounds an alarm or the sensor data acquired by the sensor unit 103 is reported to an insurance company at the time of detecting abnormal vibration at the time of occurrence of a malfunction such as an accident or when the vehicle is damaged by vehicle burglary at the time of parking or stopping. In a case where the vehicle is damaged when the user using the sharing car parks or stops and leaves the vehicle, there is a possibility that the case may be an objective circumstantial evidence.

FIGS. 9 and 10 are diagrams for describing an example of processing of notifying a user of a transaction between a vehicle and an external device in the vehicle payment system according to the present embodiment. In this figure, the illumination of the vehicle 1 is directed to illuminate the sidewalk in the right broken-lined rectangular area. As a result, it is possible to increase the safety of the person on the sidewalk and to help reduce the amount of light (amount of electricity used) of the streetlamp in a case where there is sufficient brightness. For example, it is conceivable that it is broadcasted that the vehicle 1 (provision unit 106d) illuminates the sidewalk, and the illumination or sensor that has received the wireless communication signal rebates 10 points to the vehicle 1. In such a case, the transaction unit 106c displays “illumination of sidewalk (*** city) +10 p” on the screen of the information input/output unit 104 (IVI) of the vehicle 1, and can notify the user of acquisition of 10 points from the local government (*** city) by the illumination of the sidewalk together with a voice.

Further, the transaction unit 106c can notify the user that the 10 points are acquired due to the illumination of the sidewalk in a more easily understandable and natural manner using the HUD. For example, the transaction unit 106cdisplays the visual information indicating that the points of “+10 p” is acquired in or near the broken-line rectangular area where the sidewalk is illuminated, so that the user can easily understand that the user acquires the 10 points by the illumination of the sidewalk. A scene over the windshield in FIG. 9 illustrates this, and “provision of traffic volume +5 p” and “illumination of sidewalk +10 p” displayed at the lower part of the windshield in FIG. 10 (with respect to the direction in which the point is generated by the installed HUD) are also examples of the visual information indicating the acquisition of the point. Furthermore, at this time, it is also conceivable that the transaction unit 106c notifies the user of the direction in an easy-to-understand manner by stereophonic sound such that the notification sound making a notification of point acquisition is made from the direction of the broken-line rectangular area illuminated.

Here, the transaction unit 106c may assign, to the point information, spatial position information indicating at which point on the three-dimensional spatial coordinates the entity that has rebated the point (for example, illumination) has rebated the point. As a result, the IVI or the HUD can display the visual information about the point rebate at the spatial position of the point rebate. Note that note marks in the broken-line rectangular area indicate that the virtual sound source position is at the position, and may or may not be actually displayed as visual information with the IVI or HUD.

Note that, although the vehicle 1 broadcasts the information indicating that the vehicle 1 (provision unit 106d) illuminates the sidewalk, the information about the illumination of the sidewalk may be transmitted to the external device 20 such as a streetlamp after mutual authentication with the external device 20. The mutual authentication may include at least one of a vehicle ID, a vehicle wallet, a location of sidewalk lighting from the vehicle 1, illuminance, information about illumination time, a user ID, an electronic key being used, a user wallet, an external device ID on an information reception side, business operator information about the external device 20, information about a consideration for information provision or service provision, and information about a reward message.

Similarly, it is conceivable that the vehicle 1 (provision unit 106d) broadcasts information about the traffic volume, and a traffic signal at an intersection that has received the wireless communication signal rebates the 5 points to the vehicle 1. In this case as well, it is conceivable that the transaction unit 106c notifies the user in an easy-to-understand manner via visual information by the IVI, the HUD, or the information terminal 6, or via audio information.

Note that although the vehicle 1 (provision unit 106d) broadcasts the information about the traffic volume, the information about the traffic volume may be transmitted to a traffic signal after mutual authentication with the traffic signal or the like. The mutual authentication may include at least one of a vehicle ID, a vehicle wallet, a type of sensing data regarding a traffic volume from the vehicle 1, a measurement date and time, a measurement position, information about measurement accuracy, a user ID, an electronic key being used, a user wallet, an external device ID on an information reception side, business operator information about the external device 20, information about a consideration for information provision or service provision, and information about a reward message.

In a case where the vehicle 1 exchanges information with an unidentified number of communication devices around the vehicle 1 via wireless communication, it is conceivable that such a large number of transactions and value exchanges are performed. In such a case, when a transaction can be performed without exchanging the settlement means of the user (including the temporary user) of the vehicle 1 with these communication devices, privacy concerns are reduced, and it can be expected that the number of users who wish to provide information increases. In addition, a partner (fueling station, charging station, ETC gate, local government, road management company, etc.) who conducts a transaction with the user does not need to handle personal information in individual transactions, and there is an advantage that a management burden due to handling of personal information and a possibility of leaking personal information about the user can be avoided.

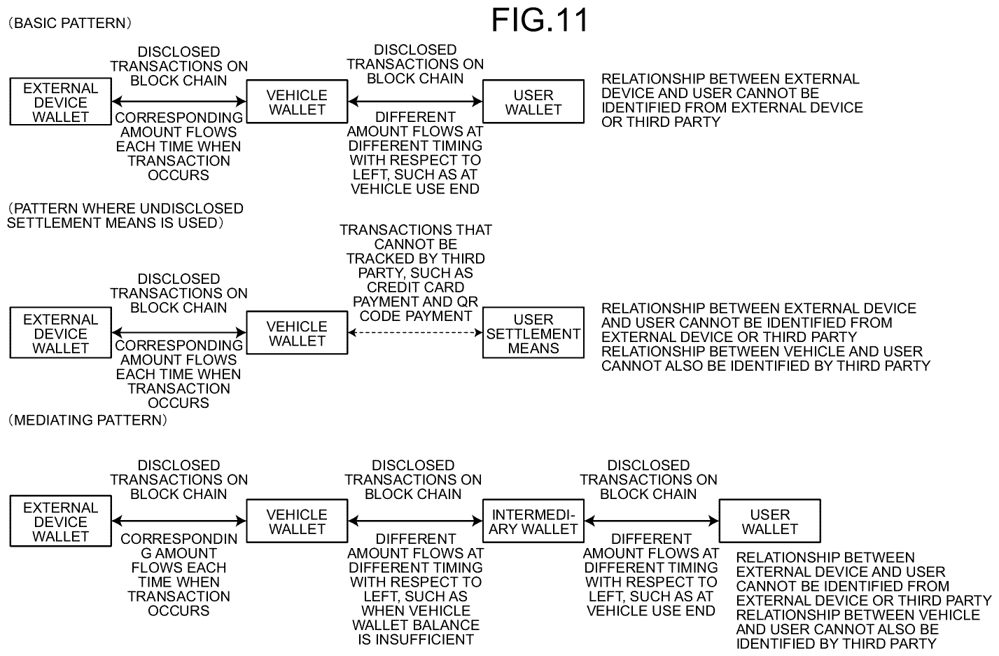

FIG. 11 is a diagram for describing an example of a pattern of a monetary value (as described above, not only cash but also points issued by companies and local governments and tokens traded on a block chain are included) transaction between an external device, a vehicle, and a user in the vehicle payment system according to the present embodiment.

First, an example (upper stage) of a basic pattern of a transaction between the external device 20, the vehicle 1, and the user will be described. In a case where the settlement means of the external device 20, the vehicle 1, and the user are all wallets recorded and managed in the block chain, there is a possibility that all transaction histories (indicated by solid arrows) are viewed by a third party on the block chain. Therefore, it is conceivable to change two transaction timings and transaction amounts. For example, the transaction unit 106c may perform a transaction between the external device 20 (external device wallet) and the vehicle 1 (vehicle wallet) every time a transaction occurs, and the vehicle 1 (vehicle wallet and user (user wallet) may collectively perform processing by adding a cost not related to the external device 20, such as a vehicle usage fee, in addition to a transaction amount accumulated at the end of use or the like. In this way, even when the transaction history on the block chain can be tracked by the third party, it is difficult for the external device 20 and the third party to identify the relationship between the external device 20 and the user since the monetary value (transaction amount) and the transaction date and time of the two transactions are greatly different.

The following is an example (middle stage) of a pattern in which transactions between the external device 20, the vehicle 1, and the user are conducted using a payment method that is not publicly available. In the case of a transaction using a wallet recorded in a block chain, there is a possibility that all transaction histories (indicated by solid arrows) are viewed from a third party on the block chain. Therefore, it is conceivable to employ a means (indicated by a broken arrow) in which a transaction between the vehicle 1 and the user is not recorded on the block chain. For example, it is conceivable that the transaction unit 106c exchanges a transaction between each wallet between the external device 20 and the vehicle 1 on the block chain, and the vehicle 1 and the user perform the transaction by a means that is not recorded on the block chain such as a credit card. Of course, other than a credit card, a bank account, an electronic money account, or the like may be used.

Note that, in this case, one or more billing requests are issued from the vehicle wallet to the settlement means (user wallet) of the user. It is conceivable that it is complicated if the user is requested to confirm the request through the information terminal 6 or the like every time. Therefore, the user may take the address of the vehicle wallet into the information terminal 6 (application of the information terminal 6), and permit the company providing the settlement means to automatically make the payment without requiring the user to confirm the request from the vehicle wallet each time as long as the request is equal to or less than a certain amount of money or satisfies a certain condition during the vehicle use period (during notification of start and end from the information terminal 6 (application of the information terminal 6)). This permission may be performed via the information input/output unit 104 such as the information terminal 6 (application of the information terminal 6) or the IVI of the vehicle 1. This way makes it difficult to identify the relationship between the vehicle 1 and the user from the third party. Of course, the relationship between the external device 20 and the user is more difficult to identify.

The following is an example (lower stage) of a pattern in which transactions between the external device 20, the vehicle 1, and the user are conducted using a payment method that mediates between them. In a case where the user's settlement means is a wallet, of an individual or company, that the user on the block chain uses, a transaction record may remain on the block chain and it may be seen by a third party. In this case, the transaction unit 106c may perform the transaction via the intermediary wallet for mediation without the vehicle wallet and the user wallet directly performing the transaction. When the same amount is traded each time a transaction occurs, it is easy to track from a third party, and there is a possibility that the relationship between the external device 20 and the user can be disclosed. Therefore, for example, it is conceivable to change the transaction timing and/or the transaction amount using the intermediary wallet.

In the case of a sharing car, it is conceivable to perform a transaction every time a transaction between the external device 20 and the vehicle 1 that occurs during use occurs. The vehicle wallet may transact with the intermediary wallet every time the same amount of transaction occurs during use, or may transact with the intermediary wallet collectively after the end of use. On the other hand, the intermediary wallet may transact with the user wallet at an each or at a batch transaction timing with the vehicle 1, at a timing different from that of the transaction amount, and with the amount different from the transaction amount.

For example, every time a transaction occurs, the external device wallet and the vehicle wallet transact the amount at the timing of the occurrence. The vehicle wallet and one of the intermediary wallets owned by the vehicle management company of the vehicle perform a transaction for securing the balance of the vehicle wallet at a certain level or more at a timing different from the timing of occurrence of the transaction with the external device and with the amount at the different timing, such as the timing when the balance of the vehicle wallet falls below a certain amount. The same intermediary wallet described above or another intermediary wallet that are owned by the vehicle management company and the wallet of the user transact the use fee at a timing corresponding to a period of the vehicle use by the user, more specifically, for example, the transaction unit 106c transacts the use fee for the use of the vehicle 1 including the transaction total between the external device 20 and the vehicle 1 at the end of the use of the vehicle 1. In this way, even when all transactions are visualized on the block chain, it is possible to make it difficult to track individual transactions from a third party because the transaction amount and the transaction date and time are greatly different. In this way, it is possible to make it difficult to identify the relationship between the vehicle 1 and the user from the third party. Of course, the relationship between the external device 20 and the user is more difficult to identify.

As described above, according to the vehicle payment system according to the present embodiment, in a case where the vehicle 1 has the wallet (settlement means), transaction is performed between the external device 20 and the vehicle 1, and transaction is performed between the vehicle 1 and the user wallet (settlement means) of the user (information terminal 6), whereby it is possible to prevent information (in particular, a user ID, an ID of the information terminal 6, an email address, a telephone number, personal wallet address information owned by the user, and the like.) of the user from leaking to the external device 20 at the time of transaction.

The program executed by the vehicle 1 of the present embodiment is provided by being incorporated in advance in a read only memory (ROM) or the like. The program executed by the vehicle 1 of the present embodiment may be provided by being recorded in a computer-readable recording medium such as a CD-ROM, a flexible disk (FD), a CD-R, a digital versatile disk (DVD), or an SD card as a file in an installable format or an executable format.

Furthermore, the program executed by the vehicle 1 of the present embodiment may be stored on a computer connected to a network such as the Internet and provided by being downloaded via the network. In addition, the program executed by the vehicle 1 of the present embodiment may be provided or distributed via a network such as the Internet.

Furthermore, in the present embodiment, in the vehicular system, an example of a processor (arithmetic unit 106) such as a central processing unit (CPU) realizes the acquisition unit 106a, the link unit 106b, the transaction unit 106c, and the provision unit 106d by executing various kinds of programs stored in the ROM (memory 107), the RAM, or the like using the random access memory (RAM) or the like as a work area.

According to a control method according to an aspect of the present disclosure, it is possible to further improve the technology related to payment or receipt of money by a user of a vehicle.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control method executed by a vehicular system to be mounted on a vehicle, the control method comprising:
acquiring, from a communication terminal of a user, first wallet information indicating a first wallet associated with authentication information acquired from the communication terminal after the authentication information is determined to be valid by the vehicular system or a computer communicable with the vehicular system;
linking vehicle wallet information indicating a vehicle wallet managed by the vehicle to the first wallet information; and
storing link information indicating that the vehicle wallet information and the first wallet information are linked, in a memory in the vehicular system.

2. The control method according to claim 1, wherein
the communication terminal manages a plurality of electronic keys available to the user and a plurality of pieces of wallet information indicating a plurality of wallets held by the user in association with each other,
the authentication information includes a first electronic key selected by the user from the plurality of electronic keys, and
the first wallet information associated with the first electronic key among the plurality of pieces of wallet information managed by the communication terminal is acquired from the communication terminal after the authentication information is determined to be valid.

3. The control method according to claim 2, wherein
the plurality of pieces of wallet information are information related to a plurality of settlement services available to the user, and
the first electronic key is selected based on one selected by the user from among the plurality of settlement services via a GUI of the communication terminal.

4. The control method according to claim 2, wherein
the plurality of electronic keys include a company key associated with a company to which the user belongs and a personal key of the user,
company wallet information indicating a company wallet managed by the company is linked to the vehicle wallet information as the first wallet information in a case where the selected first electronic key is the company key, and
personal wallet information indicating a wallet of the user is linked to the vehicle wallet information as the first wallet information in a case where the selected first electronic key is the personal key.

5. The control method according to claim 2, further comprising:
executing, in response to a request by an external device outside the vehicle or the vehicular system, a payment process for paying money to an external wallet of the external device from the first wallet via the vehicle wallet, wherein
the payment process includes paying money to the external wallet from the vehicle wallet based on the vehicle wallet information, and receiving money paid from the first wallet to the vehicle wallet based on the vehicle wallet information and the first wallet information.

6. The control method according to claim 5, wherein
payment of the money from the vehicle wallet to the external wallet is made without transmitting an ID for identifying the user or the communication terminal, and the first wallet information to the external device.

7. The control method according to claim 5, wherein
the vehicle wallet information includes a vehicle wallet address indicating an address of the vehicle wallet,
the first wallet information includes a first wallet address indicating an address of the first wallet,
payment from the vehicle wallet to the external wallet is made by recording, on a block chain, a first payment transaction using an address of the external wallet acquired from the external device and the vehicle wallet address, and
payment from the first wallet to the vehicle wallet is made by recording, on the block chain, a second payment transaction using the first wallet address and the vehicle wallet.

8. The control method according to claim 7, wherein
the payment from the vehicle wallet to the external wallet is made at a first timing when a request for payment occurs between the external device and the vehicle, and
the payment from the first wallet to the vehicle wallet is made at a second timing after the first timing.

9. The control method according to claim 8, wherein the second timing is a timing at which the user suspends or ends use of the vehicle, or a timing at which a preset period ends.

10. The control method according to claim 7, wherein
payment of a first amount of money requested by the external device is made in the payment from the vehicle wallet to the external wallet, and
payment of a second amount of money different from the first amount of money is made in the payment from the first wallet to the vehicle wallet.

11. The control method according to claim 5, further comprising
acquiring permission information from the communication terminal in advance after linking the vehicle wallet information to the first wallet information, wherein
the permission information indicates that the vehicular system has temporary authority to request and execute money transfer from the first wallet to the vehicle wallet, and
the vehicular system executes receipt of payment from the first wallet to the vehicle wallet based on the permission information before or after the payment from the vehicle wallet to the external wallet.

12. The control method according to claim 7, wherein
the payment from the first wallet to the vehicle wallet is made in advance by transferring a predetermined amount from the first wallet to the vehicle wallet after linking the vehicle wallet information to the first wallet information, and
the payment from the vehicle wallet to the external wallet is made within the predetermined amount at a timing when a request for payment occurs between the external device and the vehicle.

13. The control method according to claim 5, wherein
the vehicle wallet information includes a vehicle wallet address indicating an address of the vehicle wallet,
payment from the vehicle wallet to the external wallet is made by recording, on a block chain, a payment transaction using the vehicle wallet address, and
the money paid from the first wallet to the vehicle wallet is received by a settlement method that does not involve recording on the block chain.

14. The control method according to claim 5, wherein
the payment process is executed through an intermediary wallet different from the vehicle wallet, in addition to the vehicle wallet,
receipt of the money from the first wallet in the payment process includes payment from the first wallet to the intermediary wallet and payment from the intermediary wallet to the vehicle wallet, and
payment from the vehicle wallet to the external wallet, the payment from the intermediary wallet to the vehicle wallet, and the payment from the first wallet to the intermediary wallet are made by recording, on a block chain, respective payment transactions.

15. The control method according to claim 5, wherein
a payment report indicating that the payment process is completed is transmitted to the communication terminal after the payment process, and
the payment report includes payee information for identifying the external device or the external wallet, and information about a payment amount.

16. The control method according to claim 5, wherein
after the payment process, a payment report indicating that the payment process is completed is displayed on a display mounted on the vehicle; and
display content of the payment report includes a display object for identifying the external device.

17. The control method according to claim 5, wherein
the plurality of electronic keys include a company key associated with a company to which the user belongs and a personal key of the user,
in a case where the selected first electronic key is the company key,
company wallet information indicating a company wallet managed by the company is linked to the vehicle wallet information as the first wallet information, and
after the payment process, a payment report indicating that the payment process using the company wallet is completed is transmitted to a company server associated with the company to which the user belongs, and
in a case where the selected first electronic key is the personal key,
personal wallet information indicating a wallet of the user is linked to the vehicle wallet information as the first wallet information, and
after the payment process, a payment report indicating that the payment process using the wallet of the user is completed is transmitted to the communication terminal or a personal server used by the user.

18. The control method according to claim 1, further comprising
performing, in response to a request by an external device outside the vehicle or the vehicle, a reception process for receiving money paid to the first wallet via the vehicle wallet from an external wallet of the external device, wherein
the reception process includes:
receiving money paid from the external wallet to the vehicle wallet based on the vehicle wallet information; and
remitting money from the vehicle wallet to the first wallet based on the vehicle wallet information and the first wallet information.

19. A non-transitory computer-readable medium on which programmed instructions are stored, wherein the programmed instructions, when executed by a computer in a vehicular system to be mounted on a vehicle, or communicable with the vehicular system, cause the computer to perform:
acquiring, from a communication terminal of a user, first wallet information indicating a first wallet associated with authentication information acquired from the communication terminal after the authentication information is determined to be valid;
linking vehicle wallet information indicating a vehicle wallet managed by the vehicle to the first wallet information; and
storing link information indicating that the vehicle wallet information and the first wallet information are linked in a memory in the vehicular system.

20. A control device in a vehicular system to be mounted on a vehicle or a computer capable of communicating with the vehicular system, the control device comprising:
a processor; and
a memory in which a program for causing the processor to execute a predetermined procedure is stored, wherein
the processor, based on the program, performs:
acquiring, from a communication terminal of a user, first wallet information indicating a first wallet associated with authentication information acquired from the communication terminal after the authentication information is determined to be valid;
linking vehicle wallet information indicating a vehicle wallet managed by the vehicle to the first wallet information; and
storing link information indicating that the vehicle wallet information and the first wallet information are linked in a memory in the vehicular system.
